(19) United States
(12) Patent Application Publication
(10) Pub. No.: US 2026/0269253 A1
(43) Pub. Date: Sep. 10, 2026

(54) SECONDARY BATTERY INCLUDING ELECTRODE PLATE HAVING IMPROVED FLATNESS AND METHOD OF MANUFACTURING THE SAME

(71) Applicant: Samsung SDI Co., Ltd., Yongin-si (KR)

(72) Inventor: Misun Lee, Yongin-si (KR)

(73) Assignee: Samsung SDI Co., Ltd., Yongin-si (KR)

(21) Appl. No.: 19/454,868

(22) Filed: Jan. 21, 2026

(30) Foreign Application Priority Data
Mar. 5, 2025 (KR) 10-2025-0028114

(51) Int. Cl. H01M 4/62; H01M 4/13; H01M 10/058; H01M 50/103; H01M 50/105; H01M 50/107; H01M 50/536

(52) U.S. Cl. CPC H01M 4/62; H01M 4/13; H01M 10/058; H01M 50/103; H01M 50/105; H01M 50/107; H01M 50/536

(57) ABSTRACT

The present disclosure provides a method of improving the flatness of an electrode plate constituting an electrode assembly. According to embodiments of the present disclosure, provided is a secondary battery including an electrode assembly including an electrode plate including an electrode tab attached to an electrode plate substrate, and an exterior case accommodating the electrode assembly, wherein the electrode plate of the electrode assembly further includes a first flatness reinforcement layer applied to a stepped portion between a surface of the electrode tab and a surface of the electrode plate substrate. Accordingly, the flatness of the electrode plate constituting the electrode assembly may be uniformly improved, thereby maximizing the space utilization of the secondary battery and the stacking density of electrode plates to achieve an effect of increasing capacity, and inducing uniform electrochemical behavior between the flat electrode plates to suppress an increase in internal resistance, extend the lifetime, and improve the safety of the secondary battery.

### CROSS-REFERENCE TO RELATED APPLICATIONS

This present application claims priority to and the benefit under 35 U.S.C. §119(a)-(d) of Korean Patent Application No. 10-2025-0028114, filed on Mar. 5, 2025, in the Korean Intellectual Property Office, the entire disclosure of which is incorporated herein by reference.

### FIELD

Aspects of some embodiments of the present disclosure relate to a secondary battery, and more particularly, to a secondary battery including an electrode plate having improved flatness and a method of manufacturing the same.

### BACKGROUND

Secondary batteries are batteries that can be charged and discharged, unlike primary batteries that cannot be recharged. In general, the secondary battery includes an electrode assembly including a positive electrode plate, a negative electrode plate, and a separator.

The herein information disclosed in this Background section is for enhancement of understanding of the background of the present disclosure, and therefore, it may contain information that does not constitute a related (or prior) art.

### SUMMARY

The present disclosure proposes a method for improving the flatness of an electrode plate constituting an electrode assembly.

According to aspects of the present disclosure for solving the herein technical problem, a secondary battery includes: an electrode assembly including an electrode plate including an electrode tab attached to an electrode plate substrate; and an exterior case accommodating the electrode assembly, wherein the electrode plate of the electrode assembly further includes a first flatness reinforcement layer applied to a stepped portion between a surface of the electrode tab and a surface of the electrode plate substrate.

According to aspects of the present disclosure for solving the herein technical problem, a method of manufacturing a secondary battery includes: manufacturing an electrode plate by coating an electrode material on a substrate; welding an electrode tab to the substrate of the manufactured electrode plate; applying a first flatness reinforcement layer to a stepped portion caused by a height difference between a surface of the electrode tab and a surface of the substrate; manufacturing an electrode assembly by winding the electrode plate to which the flatness reinforcement layer is applied; and accommodating the electrode assembly in an exterior case of the secondary battery.

Aspects and features of the present disclosure are not limited to those described herein, and other aspects and features not specifically mentioned herein will be clearly understood by those skilled in the art from the description of the present disclosure herein.

### BRIEF DESCRIPTION OF THE DRAWINGS

The following drawings attached to the present specification illustrate embodiments of the present disclosure and further describe aspects and features of the present disclosure together with the detailed description of the present disclosure. Thus, the present disclosure should not be construed as being limited to the drawings, in which:

FIG. 1 is a schematic view illustrating an exterior of an electrode assembly of a secondary battery according to some embodiments of the present disclosure;

FIG. 2 is a schematic view illustrating an exterior of an electrode assembly according to embodiments of the present disclosure;

FIG. 3 is a view of the electrode assembly in FIG. 2 from the electrode tabs side to show a winding structure of each electrode plate;

FIG. 4A is a view illustrating a first electrode plate illustrated in FIG. 3 in an unfolded state;

FIG. 4B is a view illustrating an opposite surface of the first electrode plate illustrated in FIG. 4A when the first electrode plate is turned over;

FIG. 5A is a view illustrating a second electrode plate illustrated in FIG. 3 in an unfolded state;

FIG. 5B is a view illustrating an opposite surface of the second electrode plate illustrated in FIG. 5A when the second electrode plate is turned over;

FIG. 6 is a flowchart of a method of manufacturing an electrode assembly according to some embodiments of the present disclosure;

FIG. 7 is a flowchart of a method of manufacturing an electrode assembly according to embodiments of the present disclosure;

FIG. 8 is a view illustrating a pouch-type secondary battery to which the electrode assembly according to some embodiments of the present disclosure is applied;

FIG. 9 is a view illustrating a cylindrical secondary battery to which the electrode assembly according to some embodiments of the present disclosure is applied;

FIG. 10 is a view illustrating a prismatic secondary battery to which the electrode assembly according to some embodiments of the present disclosure is applied;

FIG. 11 is an exemplary view of a secondary battery pack; and

FIG. 12 is an exemplary view of a vehicle equipped with the secondary battery pack.

### DETAILED DESCRIPTION

Hereinafter, embodiments of the present disclosure will be described in detail with reference to the accompanying drawings.

The terms or words used in the present specification and claims are not to be narrowly interpreted according to their general or dictionary meanings and should be interpreted as having meanings and concepts that are consistent with the technical idea of the present disclosure on the basis of the principle that an inventor can be his/her own lexicographer to appropriately define concepts of terms to describe his/her disclosure in the best way.

The embodiments described in this specification and the configurations shown in the drawings are only some embodiments of the present disclosure and do not represent all of the aspects, features, and embodiments of the present disclosure. Accordingly, it should be understood that there may be various equivalents and modifications that can replace or modify one or more embodiments or features therein described herein at the time of filing this application.

It will be further understood that the terms “includes,” “including,” “comprises,” and/or “comprising,” if used in this specification, specify the presence of stated features, integers, steps, operations, elements, and/or components but do not preclude the presence or addition of one or more other features, integers, steps, operations, elements, components, and/or groups thereof.

In the figures, dimensions of the various elements, layers, etc. may be exaggerated for clarity of illustration. In addition, the same reference numerals may be assigned to the same components in different embodiments.

References to two compared elements, features, etc. as being “the same” may mean that they are “substantially the same.” Thus, the phrase “substantially the same” may include a case having a deviation that is considered low in the art, for example, a deviation of 5% or less. In addition, uniformity of a parameter in a predetermined region may imply uniformity from an average perspective.

Although the terms first, second, and the like are used to describe various components, these components are substantially not limited by these terms. These terms are only used for distinguishing one component from another component, and unless otherwise stated, it is of course that a first component may also be a second component.

Throughout the specification, unless otherwise stated, each element may be singular or plural.

Arranging an arbitrary element “above (or below)” or “on (under)” another element may mean that the arbitrary element may contact the upper (or lower) surface of the element, and another element may also be interposed between the element and the arbitrary element located on (or under) the element.

In addition, it will be understood that if a component is referred to as being “linked,” “coupled,” or “connected” to another component, the elements may be directly “coupled,” “linked” or “connected” to each other, or another component may be “interposed” between the components.”

As used herein, the term “and/or” includes any and all combinations of one or more of the associated listed items. Further, the use of “may” if describing embodiments of the present disclosure relates to “one or more embodiments of the present disclosure.” Expressions, such as “at least one of” and “any one of,” if preceding a list of elements, modify the entire list of elements and do not modify the individual elements of the list.

Throughout the specification, if “A and/or B” is stated, it means A, B or A and B, unless otherwise stated and if “C to D” is stated, it means C or more and D or less, unless otherwise stated.

When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C.

As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed herein could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below.

The terminology used herein is for the purpose of describing embodiments of the present disclosure and is not intended to limit the present disclosure.

A positive electrode plate or the negative electrode plate may be manufactured through a coating process of coating an active material mixture on one or both surfaces of a substrate, a rolling process of compressing and elongating an electrode plate coated with the mixture by the coating process to make the electrode plate thin and flat, a slitting process of cutting the electrode plate coated in multiple rows in a longitudinal direction and separating the electrode plate into individual electrode plates, a notching process of cutting each separated electrode plate in a transverse direction and removing unnecessary portions, and a process of attaching an electrode tab to an uncoated portion of an electrode plate substrate.

One or more electrode tabs are attached to the electrode plate that constitutes the electrode assembly used in the secondary battery, and in some cases, various lamination tapes may also be attached. The flatness of the electrode plate may be affected by a step caused by a height difference between the electrode plate substrate and the electrode tab or the lamination tape.

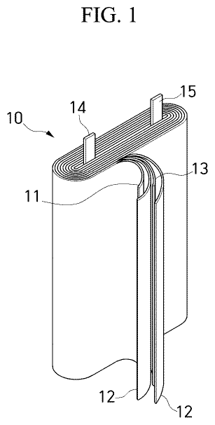

FIG. 1 is a schematic view illustrating an exterior of an electrode assembly of a secondary battery according to some embodiments of the present disclosure.

As illustrated, an electrode assembly 10 may be formed by winding a first electrode plate 11, a separator 12, and a second electrode plate 13. Since the electrode assembly 10 is configured by winding the first electrode plate 11, the separator 12, and the second electrode plate 13 in a roll form, it is referred to as a winding-type electrode assembly or a jelly roll. The first electrode plate 11 of the electrode assembly 10 may serve as a negative electrode, and the second electrode plate 13 may serve as a positive electrode, although the opposite arrangement is also possible.

The first electrode plate 11, when it is a negative electrode, may be formed by applying (e.g., coating or depositing) active material, such as graphite or carbon, onto an electrode substrate formed of a metal foil, such as copper, a copper alloy, nickel, or a nickel alloy. The first electrode plate 11 may include a first electrode tab 14 (e.g., a first uncoated portion), which is a region to which the first electrode active material is not applied. The first electrode tab 14 may be connected to an external first terminal. In some embodiments, when the first electrode plate 11 is manufactured, the first electrode tab 14 may be formed by being cut in advance to protrude to (or protrude from) one side of the electrode assembly 10, or the first electrode tab 14 may protrude to one side of the electrode assembly 10 more than (e.g., farther than or beyond) the separator 12 without being separately cut.

The second electrode plate 13, when it is a positive electrode, may be formed by applying (e.g., coating or depositing) active material, such as a transition metal oxide, onto an electrode substrate formed of a metal foil, such as aluminum or an aluminum alloy. The second electrode plate 13 may include a second electrode tab 15 (e.g., a second uncoated portion), which is a region to which the second electrode active material is not applied. The second electrode tab 15 may be connected to an external second terminal. In some embodiments, the second electrode tab 15 may be formed by being cut in advance to protrude to the other side (e.g., the opposite side) of the electrode assembly 10 when the second electrode plate 13 is manufactured, or the second electrode plate 13 may protrude to the other side of the electrode assembly more than (e.g., farther than or beyond) the separator 12 without being separately cut.

The separator 12 prevents a short-circuit between the first electrode plate 11 and the second electrode plate 13 while allowing movement of lithium ions therebetween. The separator 12 may be made of, for example, a polyethylene film, a polypropylene film, a polyethylene-polypropylene film, or the like.

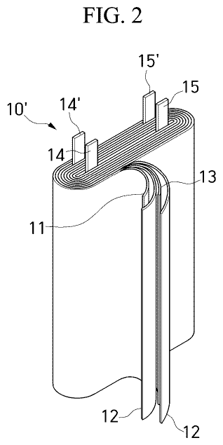

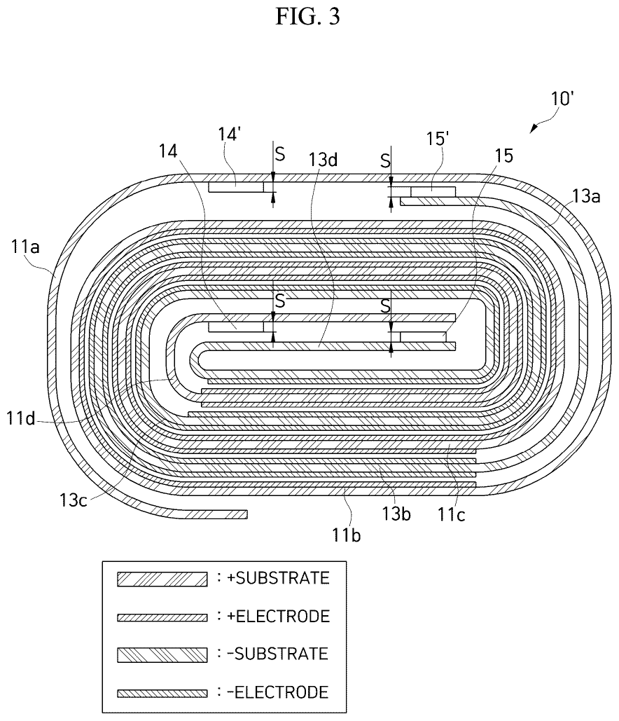

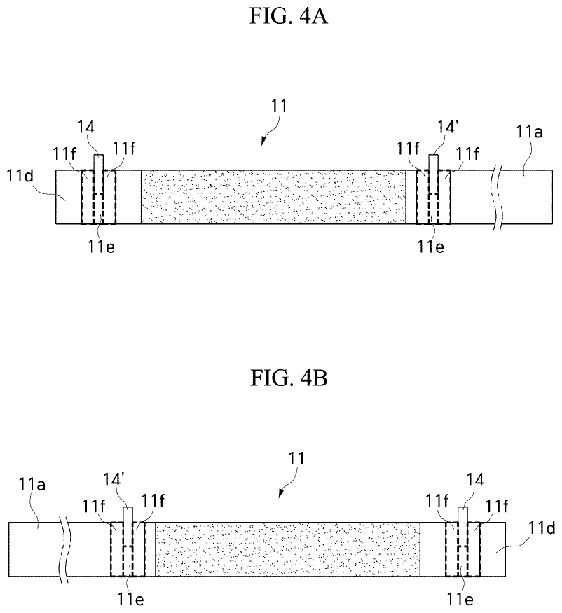

In some embodiments, the electrode assembly 10 may be accommodated in a housing along with an electrolyte. In a pouch-type secondary battery, an electrode assembly 10 may be accommodated in a pouch made of flexible material (see, e.g., FIG. 2). In a cylindrical or prismatic secondary battery, an electrode assembly 10 may be accommodated in a cylindrical or prismatic metal or composite casing (see, e.g., FIGS. 3 and 4).

Hereinafter, suitable materials that may be usable for the secondary battery according to embodiments of the present disclosure will be described.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c<0.5, 0≤α≤2); LiₐNi_{1-b-c}Mn_{b}X_{c}O_{2-α}D_{α} (0.90≤a≤1.8, 0≤b≤0.5, 0≤c≤0.5, 0≤α≤2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the herein formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a substrate and a positive electrode active material layer formed on the substrate. The positive electrode active material layer may include a positive electrode active material and may further include a binder and/or a conductive material.

The content of the positive electrode active material is in a range of about 90 wt % to about 99 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The substrate may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOₓ (0<x≤2), a Si-based alloy, or a combination thereof.

The silicon-carbon composite may be a composite of silicon and amorphous carbon. According to embodiments, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the central core.

A negative electrode for a lithium secondary battery may include a substrate and a negative electrode active material layer disposed on the substrate. The negative electrode active material layer may include a negative electrode active material and may further include a binder and/or a conductive material.

For example, the negative electrode active material layer may include about 90 wt % to about 99.5 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode substrate, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film including two or more layers thereof may be used.

The separator may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer including (or containing) an organic material and a coating layer including (or containing) an inorganic material that are stacked on each other.

FIG. 2 is a schematic view illustrating an exterior of an electrode assembly according to other embodiments of the present disclosure.

In an electrode assembly 10′ illustrated in FIG. 1, electrode tabs 14′ and 15′ are additionally provided to increase current capacity. As illustrated in FIG. 2, a structure having a plurality of electrode tabs 14, 14′, 15, and 15′ is referred to as a multi-tab structure. In the electrode assembly 10′ of the multi-tab structure, first electrode tabs 14 and 14′ and second electrode tabs 15 and 15′ may be welded to each other, and terminals exposed to the outside may be electrically connected to the welded electrode tabs.

In FIG. 2, a substrate and electrode material of a first electrode plate 11 and a second electrode plate 13, and a material of a separator 12 are substantially the same as those described for the electrode assembly 10 in FIG. 1, and therefore a detailed description thereof will be omitted.

FIG. 3 is a view of the electrode assembly 10′ in FIG. 2 from the electrode tabs 14, 14′, 15, and 15′ side to show a winding structure of each electrode plate. For convenience of understanding, the separator 12 is omitted.

In the electrode assembly 10′ in FIG. 3, first electrode plates 11a, 11b, 11c, and 11d are assumed to serve as positive electrodes (+), and second electrode plates 13a, 13b, 13c, and 13d are assumed to serve as negative electrodes (−), but the present disclosure is not limited thereto.

In the winding-type electrode assembly 10′ according to the embodiments illustrated in FIG. 3, a positive electrode plate has, at its outermost side, a first double-sided uncoated portion 11a, which is a region in which neither side of the substrate is coated with a positive electrode material, thereby forming an outer finishing portion. Further, as the positive electrode plate extends inward toward a central core (e.g., empty central core) of the electrode assembly 10′, the positive electrode plate sequentially includes a single-sided uncoated portion 11b, which is a region in which only one side of the substrate is coated with the positive electrode material, a double-sided coated portion 11c, which is a region in which both sides of the substrate are coated with the positive electrode material, and a second double-sided uncoated portion 11d, which is a region in which neither side of the substrate is coated with the positive electrode material. A first positive electrode tab 14 is attached to the second double-sided uncoated portion 11d located in the central core.

Further, a second positive electrode tab 14′ is attached to the first double-sided uncoated portion 11a having an outer finishing portion, at a position parallel to the first positive electrode tab 14. The first positive electrode tab 14 and the second positive electrode tab 14′ may be welded together. In FIG. 3, two positive electrode tabs, that is, the first positive electrode tab 14 and the second positive electrode tab 14′, are illustrated, but a larger number of positive electrode tabs are also possible.

In addition, in FIG. 3, a negative electrode plate is located inside the positive electrode plate, and as the electrode assembly 10′ extends inward from the outer side toward the central core, the electrode assembly 10′ sequentially includes a first double-sided uncoated portion 13a, which is a region in which neither side of the substrate is coated with a negative electrode material, a double-sided coated portion 13b, which is a region in which both sides of the substrate are coated with the negative electrode material, a single-sided uncoated portion 13c, which is a region in which only one side of the substrate is coated with the negative electrode material, and a second double-sided uncoated portion 13d, which is a region in which neither side of the substrate is coated with the negative electrode material. A negative electrode tab 15 is attached to the second double-sided uncoated portion 13d located in the central core.

Further, a second negative electrode tab 15′ is attached to the first double-sided uncoated portion 11a located on the outer side, at a position parallel to the first negative electrode tab 15. The first negative electrode tab 15 and the second negative electrode tab 15′ may be welded together. In FIG. 3, two negative electrode tabs, that is, the first negative electrode tab 15 and the second negative electrode tab 15′, are illustrated, but a larger number of negative electrode tabs are also possible.

As illustrated in FIG. 3, the first positive electrode tab 14, the second positive electrode tab 14′, the first negative electrode tab 15, and the second negative electrode tab 15′ are each welded to the substrate of the corresponding electrode plate, thereby forming a step S caused by a height difference between a surface of each electrode tab and a surface of the substrate. The step S degrades the flatness of a final electrode assembly, and as a result, an uneven electrode assembly may be manufactured. Further, although not illustrated, when a lamination tape is attached to the electrode plate during manufacturing of the electrode assembly, a stepped portion is additionally formed between a surface of the lamination tape and a surface of the electrode plate substrate, thereby further degrading the flatness of the electrode plate. As an increase in energy capacity of secondary batteries has recently become an important design factor, such degraded electrode plate flatness may hinder the space utilization of the secondary battery and the stacking density of the electrode plates, and may also increase internal resistance due to non-uniform electrochemical behavior (for example, lithium-ion mobility) between electrode plates with poor flatness, thereby shortening lifetime and being disadvantageous in terms of mechanical rigidity, and ultimately having an adverse effect on performance improvement of the secondary battery. Accordingly, efforts are being made to improve the flatness of the electrode assembly of the secondary battery, particularly in the case of a winding-type electrode assembly, to 200 μm or less.

FIG. 4A is a view illustrating the first electrode plate 11 (which serves as a positive electrode in embodiments) illustrated in FIG. 3 in an unfolded state.

A flatness reinforcement layer may be applied around the first positive electrode tab 14 attached to one surface of the second double-sided uncoated portion 11d located in the central core and the second positive electrode tab 14′ attached to one surface of the first double-sided uncoated portion 11a forming an outer finishing portion. For example, the flatness reinforcement layer may include a lower flatness reinforcement layer 11e applied to a stepped portion that may occur at lower surfaces of the electrode tabs 14 and 14′ and/or a side flatness reinforcement layer 11f applied to a stepped portion that may occur at left or right sides of the electrode tabs 14 and 14′.

Meanwhile, the first positive electrode tab 14 and/or the second positive electrode tab 14′ may also be attached to an opposite surface of a display surface of the first electrode plate 11 illustrated in FIG. 4A. FIG. 4B is a view illustrating an opposite surface of the first electrode plate 11 illustrated in FIG. 4A when the first electrode plate is turned over. Similar to the case in FIG. 4A, a flatness reinforcement layer may be applied around the first positive electrode tab 14 attached to the other surface of the second double-sided uncoated portion 11d located in the central core and the second positive electrode tab 14′ attached to the other surface of the first double-sided uncoated portion 11a forming an outer finishing portion. Likewise, the flatness reinforcement layer may include the lower flatness reinforcement layer 11e applied to the stepped portion at the lower surfaces of each of the electrode tabs 14 and 14′, and the side flatness reinforcement layer 11f applied to the stepped portion at the left or right sides of the electrode tabs 14 and 14′.

In some embodiments, the flatness reinforcement layers 11e and 11f may be applied by applying an insulating material to a corresponding region of the electrode plate substrate. The insulating material may include, for example, polyimide (PI) or similar materials such as polysulfone, polyphenylsulfone, polyethersulfone, or polyphenylene sulfide, as well as ceramics or photocurable resins. In embodiments, the flatness reinforcement layers 11e and 11f may be applied by attaching an insulating tape to the corresponding region of the electrode plate substrate.

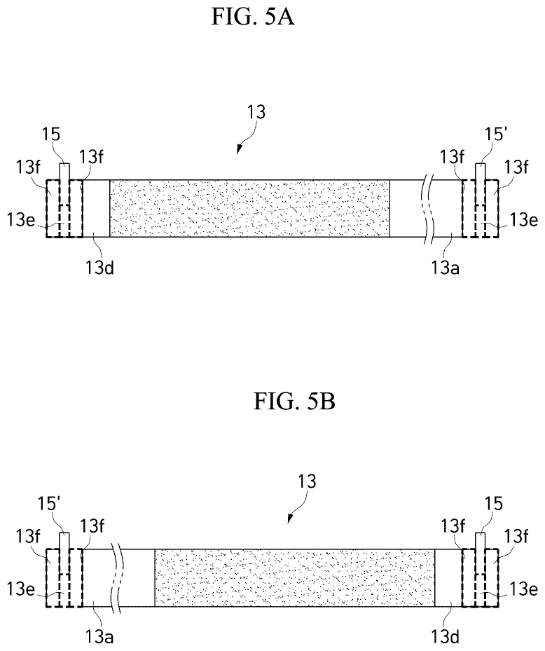

FIG. 5A is a view illustrating the second electrode plate illustrated in FIG. 3 in an unfolded state.

A flatness reinforcement layer may be applied around the first negative electrode tab 15 attached to one surface of the second double-sided uncoated portion 13d located in the central core and the second negative electrode tab 15′ attached to one surface of the first double-sided uncoated portion 13a located on the outer side. The flatness reinforcement layer may include a lower flatness reinforcement layer 13e applied to a stepped portion at lower surfaces of the electrode tabs 15 and 15′, and a side flatness reinforcement layer 13f applied to a stepped portion at left or right sides of the electrode tabs 15 and 15′.

Meanwhile, the first negative electrode tab 15 and/or the second negative electrode tab 15′ may also be attached to an opposite surface of a display surface of the second electrode plate 13 illustrated in FIG. 5A. FIG. 5B is a view illustrating an opposite surface of the second electrode plate 13 illustrated in FIG. 5A when the second electrode plate is turned over. Similar to the case in FIG. 5A, a flatness reinforcement layer may be applied around the first negative electrode tab 15 attached to the other surface of the second double-sided uncoated portion 13d located in the central core and the second negative electrode tab 15′ attached to the other surface of the first double-sided uncoated portion 13a located on the outer side. The flatness reinforcement layer may include the lower flatness reinforcement layer 13e applied to the stepped portion at the lower surfaces of each of the electrode tabs 15 and 15′, and the side flatness reinforcement layer 13f applied to the stepped portion at the left or right sides of the electrode tabs 15 and 15′.

In some embodiments, the flatness reinforcement layers 13e and 13f may be applied by applying an insulating material to a corresponding region of the electrode plate substrate. The insulating material may include, for example, polyimide (PI) or similar materials such as polysulfone, polyphenylsulfone, polyethersulfone, or polyphenylene sulfide, as well as ceramics or photocurable resins. In embodiments, the flatness reinforcement layers 13e and 13f may be applied by attaching an insulating tape to the corresponding region of the electrode plate substrate.

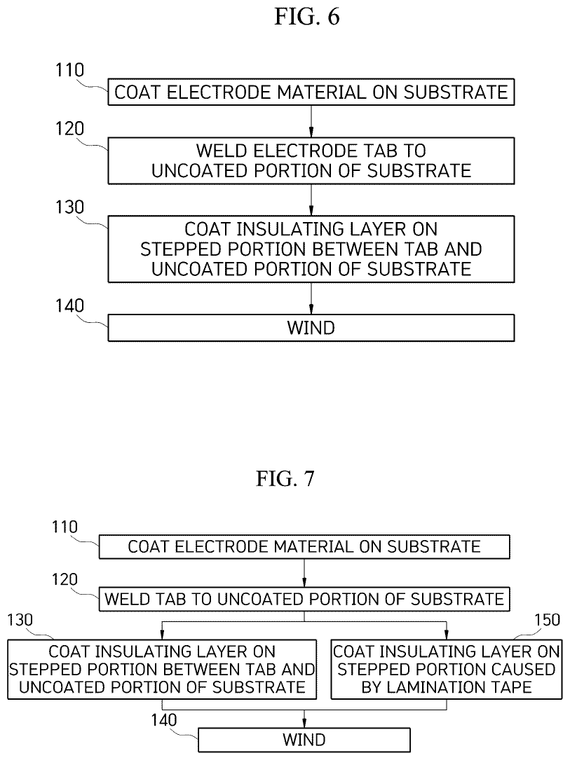

FIG. 6 is a flowchart of a method of manufacturing an electrode assembly according to some embodiments of the present disclosure.

With reference to FIGS. 3 to 5B described herein, embodiments of a method of manufacturing an electrode assembly will be described.

110: Coat an electrode material on a substrate.

For example, as described herein, by coating an electrode material on one surface and/or the other surface of the substrate of a first electrode plate 11, which may serve as a positive electrode plate, a first double-sided uncoated portion 11a, which is a region in which neither side of the substrate is coated with a positive electrode material, a single-sided uncoated portion 11b, which is a region in which only one side of the substrate is coated with the positive electrode material, a double-sided coated portion 11c, which is a region in which both sides of the substrate are coated with the positive electrode material, and a second double-sided uncoated portion 11d, which is a region in which neither side of the substrate is coated with the positive electrode material, as illustrated in FIG. 3, are formed.

In addition, by coating an electrode material on one surface and/or the other surface of the substrate of a second electrode plate 13, which may serve as a negative electrode plate, a first double-sided uncoated portion 13a, which is a region in which neither side of the substrate is coated with a negative electrode material, a double-sided coated portion 13b, which is a region in which both sides of the substrate are coated with the negative electrode material, a single-sided uncoated portion 13c, which is a region in which only one side of the substrate is coated with the negative electrode material, and a second double-sided uncoated portion 13d, which is a region in which neither side of the substrate is coated with the negative electrode material, as illustrated in FIG. 3, are formed.

120: Weld electrode tabs to uncoated portions of the substrates of each of the electrode plates 11 and 13 manufactured as described herein.

For example, in the first electrode plate 11, as illustrated in FIG. 3, a first positive electrode tab 14 may be welded to one surface and/or the other surface of the second double-sided uncoated portion 11d, which will be located in the central core of the electrode assembly after final winding. In addition, a second positive electrode tab 14′ may be welded to one surface and/or the other surface of the first double-sided uncoated portion 11a, which will be located on the outer side of the electrode assembly after final winding. Further, in the second electrode plate 13, which may serve as a negative electrode plate, a first negative electrode tab 15 may be welded to one surface and/or the other surface of the second double-sided uncoated portion 13d, which will be located in the central core of the electrode assembly after final winding. In addition, a second negative electrode tab 15′ may be welded to one surface and/or the other surface of the first double-sided uncoated portion 13a, which will be located on the outer side of the electrode assembly after final winding.

130: Apply a first flatness reinforcement layer, which is an insulating layer, to a stepped portion that may be formed due to a height difference between a surface of the electrode tab and a surface of an uncoated portion of the substrate.

For example, as illustrated in FIG. 4A or 4B, a first insulating layer may be applied to stepped portions around the first positive electrode tab 14 welded to the second double-sided uncoated portion 11d of the first electrode plate 11 and the second positive electrode tab 14′ welded to the first double-sided uncoated portion 11a (for example, at lower surfaces and/or left and right sides). Here, the “first” insulating layer (the first flatness reinforcement layer) is named in correspondence to the “second” insulating layer (the second flatness reinforcement layer) in FIG. 7 described herein. Meanwhile, as illustrated in FIG. 5A or 5B, a first insulating layer may be applied to stepped portions around the first negative electrode tab 15 welded to the second double-sided uncoated portion 13d of the second electrode plate 13 and the second negative electrode tab 15′ welded to the first double-sided uncoated portion 13a (for example, at lower surfaces and/or left and right sides). As described herein, instead of applying the insulating layer, an insulating tape may be attached. The material of the insulating layer to be applied may include, for example, polyimide (PI) or similar materials such as polysulfone, polyphenylsulfone, polyethersulfone, or polyphenylene sulfide, as well as ceramics or photocurable resins.

140: Manufacture an electrode assembly by winding the electrode plate to which an insulating layer (the flatness reinforcement layer) is applied.

For example, by winding the first electrode plate 11 and the second electrode plate 13 in a structure such as that illustrated in FIG. 3, the electrode assembly 10 in FIG. 1 or the electrode assembly 10′ in FIG. 2 is manufactured. During winding of the first electrode plate 11 and the second electrode plate 13, as described with reference to FIG. 1, a separator 12 is interposed between the first electrode plate 11 and the second electrode plate 13 and wound together.

Thereafter, the first electrode tabs 14 and 14′ and the second electrode tabs 15 and 15′ are welded, respectively, a strip conductor (not illustrated) is connected, and the electrode assembly is accommodated in an exterior case such as a pouch or can to manufacture a pouch-type, cylindrical, or prismatic secondary battery.

FIG. 7 is a flowchart of a method of manufacturing an electrode assembly according to embodiments of the present disclosure.

In the manufacturing method in FIG. 6, the first flatness reinforcement layer is applied to the stepped portion between the electrode plate substrate and the electrode tab attached thereto. However, during the process of manufacturing the electrode assembly 10, in addition to attaching the electrode tabs to the electrode plate, various lamination tapes may also be attached to the electrode plate. As with the electrode tabs, a second flatness reinforcement layer may be applied to a stepped portion that may be formed between the electrode plate substrate and the lamination tape, thereby further improving the flatness of the electrode plate. FIG. 7 is a flowchart illustrating such a method of manufacturing an electrode assembly.

110: Coat an electrode material on a substrate.

This operation is substantially the same as operation 110 described in FIG. 6, and therefore a detailed description will be omitted.

120: Weld electrode tabs to uncoated portions of the substrates of the electrode plates.

This operation is also substantially the same as operation 120 described in FIG. 6, and therefore a detailed description will be omitted.

130: Apply a first insulating layer to a stepped portion between the electrode tab and the uncoated portion of the substrate.

This operation is also substantially the same as operation 130 described in FIG. 6, and therefore a detailed description will be omitted.

150: In addition to operation 130, apply a second flatness reinforcement layer, which is an insulating layer, to a stepped portion between a lamination tape attached to the electrode plate and the electrode plate substrate.

As described herein, during the manufacturing process of the electrode assemblies 10 and 10′, when a lamination tape (not illustrated) is attached to the electrode plate and a step is formed due to a height difference with the electrode plate substrate, the second flatness reinforcement layer is applied to the stepped portion. The second flatness reinforcement layer in this operation may also be applied in the same manner as the first flatness reinforcement layer in operation 130.

For example, as can be inferred from FIG. 4A or 4B, an insulating layer may be applied or an insulating tape may be attached to a stepped portion that may occur at the left or right side of a lamination tape (not illustrated) attached to the first electrode plate 11. Similarly, as can be inferred from FIG. 5A or 5B, an insulating layer may be applied or an insulating tape may be attached to a stepped portion that may occur at the left or right side of a lamination tape (not illustrated) attached to the second electrode plate 13.

140: Manufacture an electrode assembly by winding the electrode plates to which the first and second insulating layers (the flatness reinforcement layers) are applied. During winding of the electrode plates, the separator is interposed between the first electrode plate 11 and the second electrode plate 13 and wound together.

This operation is also substantially the same as operation 140 described in FIG. 6, and therefore a detailed description will be omitted.

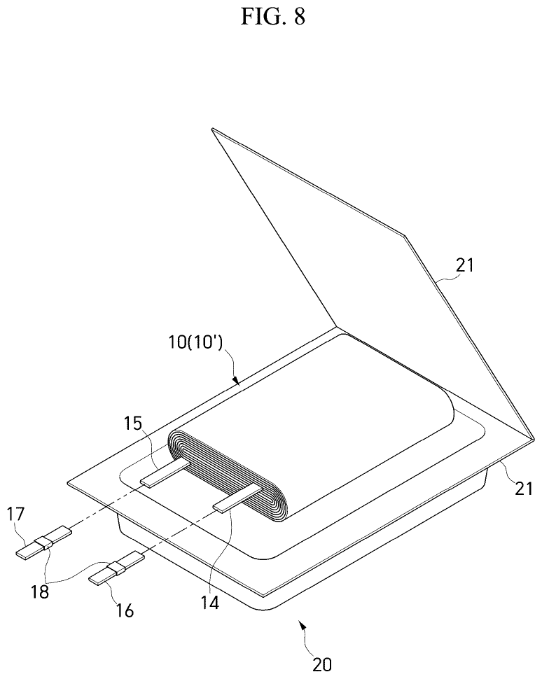

FIG. 8 is a view illustrating a pouch-type secondary battery to which the electrode assembly according to some embodiments of the present disclosure is applied.

The pouch-type secondary battery may include the electrode assembly 10 and a pouch 20 accommodating the electrode assembly 10. As illustrated in FIG. 1, the first electrode tab 14 and the second electrode tab 15 of the electrode assembly 10 may be welded to and electrically connected with an external first strip terminal 16 and an external second strip terminal 17, respectively. A tab film 18 for insulation from the pouch 20 may be attached to each of the first strip terminal 16 and the second strip terminal 17. The first strip terminal 16 and the second strip terminal 17 may be connected to a circuit board or an electrical component of a battery application product (e.g., an electronic device such as a mobile phone, a tablet, or a fan).

In the state in which the electrode assembly 10 is accommodated in the pouch 20, sealing portions 21 at the edges of the pouch 20 may be brought into contact with each other and sealed, and at this time, the sealing may be performed while the tab film 18 interposed between the sealing portions 21. Since the sealing portions 21 of the pouch 20 are formed of a heat-sealing material, and the heat-sealing material generally has weak adhesion to metal, the sealing portions 21 and the pouch 20 may be fused by interposing the tab film 18 in the form of a thin film.

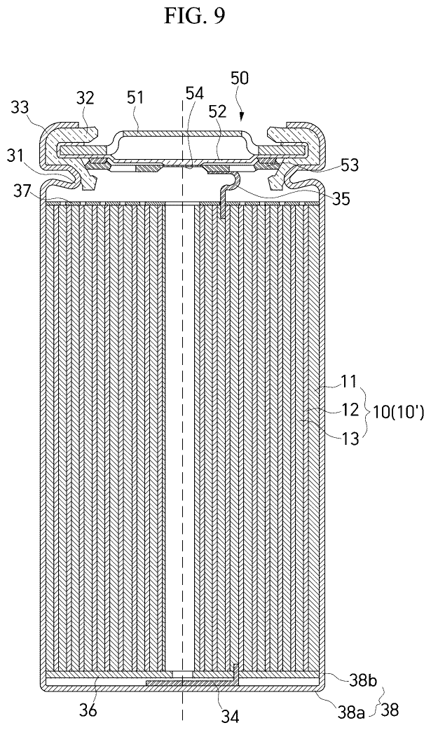

FIG. 9 is a view illustrating a cylindrical secondary battery to which the electrode assembly according to some embodiments of the present disclosure is applied.

The secondary battery includes an electrode assembly 10, 10′, a case 38 accommodating the electrode assembly 10, 10′ and an electrolyte therein, a cap assembly 50 coupled to an opening of the case 38 to seal the case 38, and an insulating plate 37 positioned between the electrode assembly 10, 10′ and the cap assembly 50 inside the case.

The case 38 accommodates the electrode assembly 10, 10′ and together with the cap assembly 50 forms the external appearance of the secondary battery. The case 38 may have a substantially cylindrical body portion 38b and a bottom portion 38a connected to one side (e.g., to one end) of the body portion 38b. A beading part 31 deformed inwardly may be formed in the body portion 38b, and a crimping part 33 bent inwardly may be formed at an open end of the body portion 38b.

The beading part 31 can reduce or prevent movement of the electrode assembly 10, 10′ inside the case 38 and can facilitate seating of the gasket 32 and the cap assembly 50. The crimping part 33 may firmly fix the cap assembly 50 by pressing the edge of the case 38 against the gasket 32. The case 38 may be formed of iron plated with nickel, for example.

The cap assembly 50 may be fixed to the inside of the crimping part 33 by a gasket 32 to seal the case 38. The cap assembly 50 may include a cap up 51, a safety vent 52, a cap down 53, an insulating member, and a sub plate 54 but is not limited thereto and may be modified in various ways.

The cap up 51 may be positioned at the uppermost part of the cap assembly 50. The cap up 51 may include a terminal part that protrudes upwardly and is connected to an external circuit, and an outlet for discharging gas may be arranged around the terminal part.

The safety vent 52 may be located under the cap up 51. The safety vent 52 may include a protrusion part that protrudes convexly downwardly and is connected to the sub plate 54, and at least one notch may be formed in the safety vent around the protrusion part.

If gas is generated due to overcharging or abnormal operation of the secondary battery, the protrusion part is deformed upwardly by the pressure and separates from the sub plate 54 while the safety vent 52 is cut (e.g., bursts or tears) along the notch. The cut safety vent 52 may prevent the secondary battery from exploding by allowing for the gas to be discharged to the outside.

The cap down 53 may be below the safety vent 52. The cap down 53 may have a first opening for exposing the protrusion part of the safety vent 52 and a second opening for gas discharge. The insulating member may be positioned between the safety vent 52 and the cap down 53 to insulate the safety vent 52 and the cap down 53.

The sub plate 54 may be under the cap down 53. The sub plate 54 may be fixed to a lower surface of the cap down 53 to block the first opening of the cap down 53, and the protrusion part of the safety vent 53 may be fixed to the sub plate 54. The first lead tab 35, which is drawn out from the electrode assembly 10, 10′ may be fixed to the sub plate 54. Accordingly, the cap up 51, the safety vent 52, the cap down 53, and the sub plate 54 may be electrically connected to the first electrode 30c of the electrode assembly 10, 10′.

The insulating plate 37 may be positioned to be in contact with the electrode assembly 10, 10′ below the beading part 13. The insulating plate 37 may have a tab opening through which the first lead tab 35 is drawn out. The cap assembly 50, which is electrically connected to the first electrode by the first lead tab, may face the electrode assembly with an insulating plate 37 interposed therebetween and may maintain a state of being insulated (e.g., electrically insulated) from the electrode assembly 10, 10′ by the insulating plate 37. Meanwhile, another insulating plate 36 may be included for insulation between the electrode assembly 10, 10′ and the bottom portion 38a of the case 38.

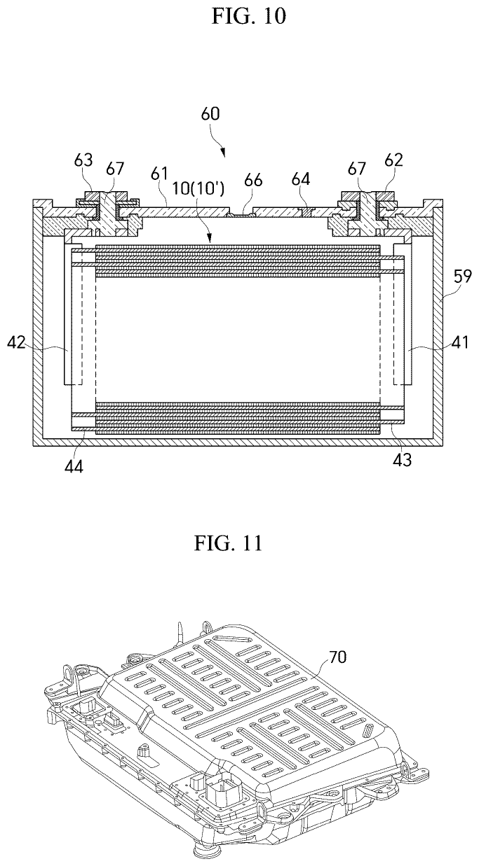

FIG. 10 is a view illustrating a prismatic secondary battery to which the electrode assembly according to some embodiments of the present disclosure is applied.

The separator prevents or substantially reduces instances of a short circuit between the first electrode and the second electrode while allowing movement of lithium ions therebetween. The separator may be made of, for example, a polyethylene film, a polypropylene film, a polyethylene-polypropylene film, or the like.

In some embodiments, the electrode assembly 10, 10′ is accommodated in the case 10 along with an electrolyte.

In the electrode assembly 10, 10′, the first current collector 41 and the second current collector 42 may be welded and connected to the first electrode tab 43 extending from the first electrode plate and the second electrode tab 44 extending from the second electrode plate, respectively.

The first current collector 41 and the second current collector 42 are connected to the first terminal 62 and the second terminal 63 through connection members 67, respectively. In some embodiments, the connection members 67 may each have an outer peripheral surface that is threaded, and may be fastened to the first terminal 62 and the second terminal 63 by screwing. However, the present disclosure is not limited thereto. For example, the connection members 67 may also be coupled to the first terminal 62 and the second terminal 63 by riveting or welding.

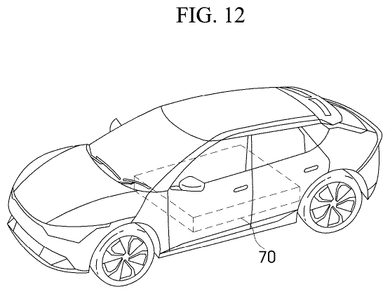

A secondary battery module may be manufactured by arranging and connecting secondary batteries according to the present disclosure in a transverse direction and/or a longitudinal direction. The arrangement of secondary batteries may be designed in terms of arrangement direction and number to obtain the desired voltage and current specifications. A secondary battery pack 70 configured to apply the secondary battery module to an actual product (e.g., an automobile) is shown in FIG. 11. The secondary battery pack may be manufactured by embedding a plurality of secondary battery modules into a pack housing designed to be mounted in an actual product. The pack housing may include related elements such as busbars for electrical connection of the secondary batteries, a cooling unit, and external terminals in addition to fasteners and electrical outlets necessary for mounting in the product. As shown in FIG. 12, the secondary battery pack may be mounted in an automobile. The automobile may be, for example, an electric vehicle, a hybrid vehicle, or a plug-in hybrid vehicle.

According to the present disclosure, the flatness of an electrode plate constituting an electrode assembly can be uniformly improved, thereby maximizing the space utilization of a secondary battery and the stacking density of electrode plates to achieve an effect of increasing capacity, and inducing uniform electrochemical behavior (for example, lithium-ion mobility) between the electrode plates to suppress an increase in internal resistance, extend lifetime, and improve safety of the secondary battery.

Although the present disclosure has been described herein with respect to embodiments thereof, the present disclosure is not limited thereto. Various modifications and variations can be made thereto by those skilled in the art within the spirit of the present disclosure as defined by the appended claims and their equivalents.

What is claimed is:

1. A secondary battery comprising:
an electrode assembly including an electrode plate including an electrode tab attached to an electrode plate substrate; and
an exterior case accommodating the electrode assembly,
wherein the electrode plate of the electrode assembly further includes a first flatness reinforcement layer applied to a stepped portion between a surface of the electrode tab and a surface of the electrode plate substrate.

2. The secondary battery as claimed in claim 1, wherein the first flatness reinforcement layer includes a lower flatness reinforcement layer applied to a lower portion of the electrode tab.

3. The secondary battery as claimed in claim 1, wherein the first flatness reinforcement layer includes a side flatness reinforcement layer applied to a side portion of the electrode tab.

4. The secondary battery as claimed in claim 1, wherein the first flatness reinforcement layer includes an insulating material applied to the electrode plate substrate.

5. The secondary battery as claimed in claim 1, wherein the first flatness reinforcement layer includes an insulating tape attached to the electrode plate substrate.

6. The secondary battery as claimed in claim 1, wherein the electrode plate of the electrode assembly further includes:
a lamination tape attached to the electrode plate substrate; and
a second flatness reinforcement layer applied to a stepped portion between a surface of the lamination tape and the surface of the electrode plate substrate.

7. The secondary battery as claimed in claim 6, wherein the second flatness reinforcement layer includes an insulating material applied to the electrode plate substrate.

8. The secondary battery as claimed in claim 6, wherein the second flatness reinforcement layer includes an insulating tape attached to the electrode plate substrate.

9. The secondary battery as claimed in claim 1, wherein the exterior case is an exterior pouch for a pouch battery.

10. The secondary battery as claimed in claim 1, wherein the exterior case is an exterior can for a cylindrical or prismatic battery.

11. A method of manufacturing a secondary battery, comprising:
manufacturing an electrode plate by coating an electrode material on a substrate;
welding an electrode tab to the substrate of the manufactured electrode plate;
applying a first flatness reinforcement layer to a stepped portion caused by a height difference between a surface of the electrode tab and a surface of the substrate;
manufacturing an electrode assembly by winding the electrode plate to which the flatness reinforcement layer is applied; and
accommodating the electrode assembly in an exterior case of the secondary battery.

12. The method as claimed in claim 11, wherein the applying of the first flatness reinforcement layer includes applying the first flatness reinforcement layer to a lower portion of the electrode tab.

13. The method as claimed in claim 11, wherein the applying of the first flatness reinforcement layer includes applying the first flatness reinforcement layer to a side surface of the electrode tab.

14. The method as claimed in claim 11, wherein the applying of the first flatness reinforcement layer includes applying an insulating material to the electrode plate substrate.

15. The method as claimed in claim 11, wherein the applying of the first flatness reinforcement layer includes attaching an insulating tape to the electrode plate substrate.

16. The method as claimed in claim 11, wherein the manufacturing of the electrode plate further includes:
attaching a lamination tape to the electrode plate substrate; and
applying a second flatness reinforcement layer to a stepped portion between a surface of the attached lamination tape and the surface of the electrode plate substrate.

17. The method as claimed in claim 16, wherein the applying of the second flatness reinforcement layer includes applying an insulating material to the electrode plate substrate.

18. The method as claimed in claim 16, wherein the applying of the second flatness reinforcement layer includes attaching an insulating tape to the electrode plate substrate.

19. The method as claimed in claim 11, wherein the accommodating of the electrode assembly in the exterior case of the secondary battery includes accommodating the electrode assembly in an exterior pouch for a pouch battery.

20. The method as claimed in claim 11, wherein the accommodating of the electrode assembly in the exterior case of the secondary battery includes accommodating the electrode assembly in an exterior can for a cylindrical or prismatic battery.
